(19) United States
(12) Patent Application Publication
(10) Pub. No.: US 2009/0150166 A1
(43) Pub. Date: Jun. 11, 2009

(54) HIRING PROCESS BY USING SOCIAL NETWORKING TECHNIQUES TO VERIFY JOB SEEKER INFORMATION

(75) Inventors: LEA T. LEITE, BOYNTON BEACH, FL (US); JONATHAN PALGON, BOYNTON BEACH, FL (US); ROBERTO VILA, HOLLYWOOD, FL (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/950,458

(22) Filed: Dec. 5, 2007

(51) Int. Cl. G06Q 10/00; G06F 17/30

(52) U.S. Cl. 705/1

(57) ABSTRACT

The present invention discloses a network accessible software application that includes an interface permitting a set of profile providers to input personal biographical information, which includes job history information and education information. The application can also include an interface enabling a set of commentators to view biographical information provided by the set of profile providers and to add input regarding this information. Software of the application can establish/calculate at least one verification score against the personal biographical information based at least in part upon the added input from the set of commentators. Further software can convey the personal information along with the verification score to a set of profile consumers. At least a portion of the commentators can have a social networking connection to the profile providers for whom the added input is provided.

### BACKGROUND

1. Field of the Invention

The present invention relates to the field of employment practices and, more particularly, to improving the hiring process by sharing job seeker information that has been verified at least in part using social networking techniques.

2. Description of the Related Art

The current job application process is fraught with many time consuming and financially costly procedures for potential employers and employees alike. One problem in particular, is the timely process of soliciting and verifying background information about a job candidate. This occurs primarily through an application form that a candidate completes. Employment applications typically contain information such as educational history, employment history, associations, and references. As these applications rarely vary considerably, the job applicant is forced to duplicate the same information for each job to which they apply. With this duplication of information, applicants sometimes make mistakes which can be detrimental to their chances of success. For example, inadvertent spelling and grammatical errors reflects negatively on prospective employees. Additionally, applicants can make errors such as incorrectly filling out important fields such as past work history and references.

Companies spend a considerable amount of money and time verifying an applicant's biographical information. For example, recruiters spend a considerable amount of time verifying an applicant's resume; time that can be better spent on searching for suitable candidates. Once an applicant's information is verified, this information is rarely shared between organizations. Thus a large amount of replication of work occurs for each company that needs to verify the candidate's information. It would be advantageous if a solution were devised that would reduce job application overhead, decrease processing delays, and provide a better experience for involved parties.

### SUMMARY OF THE INVENTION

The present invention discloses a solution for improving the efficiency of the hiring process using personal information verification based on trusted sources. In the solution, personal information about an individual engaged in the employment process can be verified using one or more practices. One technique for verifying job seeker information can include the use of a Web of trust in a social network to verify biographical data. Based on a threshold value of connections, specific information (e.g. work history, education, etc.) about an individual can be considered to be authentic. Another means to establish user authenticity can rely on using a known authority source capable of verifying personal information. This trusted source can use aggregated profile data and/or manual confirmation techniques to guarantee an individual's identity. Trusted or authority sources can include private and public records, organizational/institutional databases, and the like.

The present invention can be implemented in accordance with numerous aspects consistent with the materials presented herein. One aspect of the present invention can include a network accessible software application that includes an interface permitting a set of profile providers to input personal biographical information, which includes job history information and education information. The application can also include an interface enabling a set of commentators to view biographical information provided by the set of profile providers and to add input regarding this information. Software of the application can establish/calculate at least one verification score against the personal biographical information based at least in part upon the added input from the set of commentators. Further software can convey the personal information along with the verification score to a set of profile consumers. At least a portion of the commentators can have a social networking connection to the profile providers for whom the added input is provided. A validity of the added input can be weighed based at least in part upon a strength of and a confidence level in the social networking connection.

Another aspect of the present invention can include a method for leveraging social networking information for an employment context. The method can include a step of extracting from a social networking Web site information relating to biographical data provided as part of a resume by a profile provider. A set of verification scores for discrete entries contained in the biographical data can be algorithmically determined using the extracted information. Additional input from at least one authority source can be used to further refine the set of verification scores. The verification scores can be provided along with the biographical data to a set of hiring entities. The verification of the biographical information can be done independent of a system controlled by any of the hiring entities.

Still another aspect of the present invention can include a method for utilizing social networking technology for job application purposes. The method can include a step of a network element receiving a personal profile from a person comprising biographical information of that person. The biographical data can include job history information and education information. The biographical information can be verified based at least in part upon social networking connections associated with the person. Verified biographical information can be provided to at least one remotely located hiring entity.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for improving the efficiency of the hiring process using personal information verification based on social networking techniques and a set of trusted sources in accordance with an embodiment of the inventive arrangements disclosed herein.

FIG. 2 is a schematic diagram illustrating a set of scenarios for using a verified profile to improve the quality of business and personal relations in accordance with an embodiment of the inventive arrangements disclosed herein.

FIG. 3 is a flow chart illustrating a method for verifying provider profile information for use by a profile provider and/or consumer in accordance with an embodiment of the inventive arrangements disclosed herein.

### DETAILED DESCRIPTION OF THE INVENTION

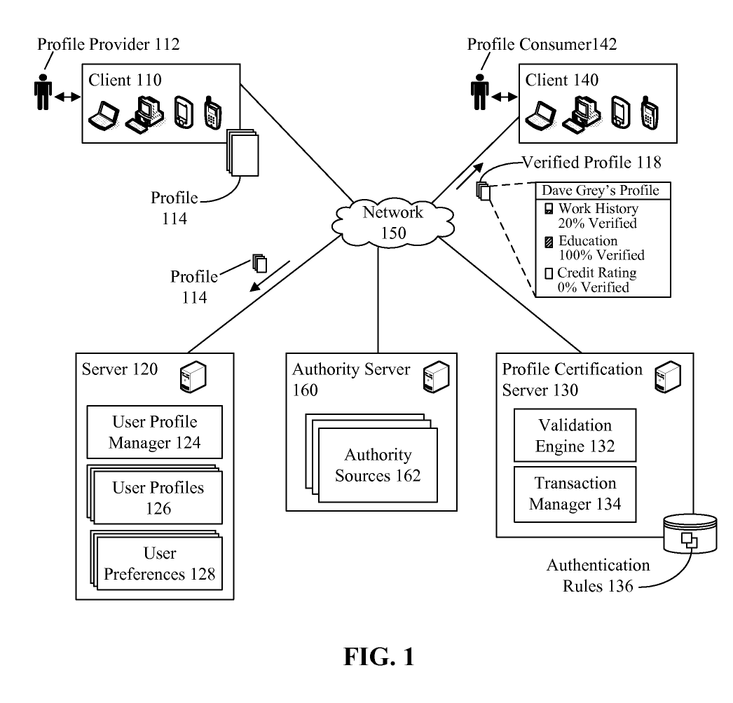

FIG. 1 is a schematic diagram illustrating a system 100 for improving the efficiency of the hiring process using personal information verification based on social networking techniques and a set of trusted sources in accordance with an embodiment of the inventive arrangements disclosed herein. Many social networking sites record biographical data about their users, which is used by other users to determine common interests that may be worthwhile to pursue. New contacts/friendships are often made by people connecting through the social networking sites with the contacts of others. Over time, circles and chains of friendships and contacts are established. System 100 leverages advantages of social networking applications for a job application process.

Job seekers, referred to as profile providers 112, can establish a personal profile on a server 120, which can include basic user 112 biographical data. Biographical data can include common information needed when applying for a job, such as education history, job history, and a set of references. The biographical data can optionally be used for social networking purposes of a social networking site in addition to being used for employment purposes. Unlike many “typical” sets of references, the references provided as part of a profile 114 can include a set of individuals who know and actively correspond with the person being profiled 112.

The system 100 can include a validation engine 130 designed to verify that information contained within a profile 114 is accurate and to be trusted. A portion of this accuracy can be based upon social networking connections. For example, a trustworthy applicant 112 should have several connections and recommendations associated with them. Each of these connections should in turn have other connections and recommendations, a third-degree of connections should also exist, and so forth. The connection network associated with a provider 112 can be analyzed by the validation engine 132 to ensure that a circle of suspect connections of people recommending each other for personal gain to take advantage of the system does not exist. Verifications can occur at multiple levels, which include at a high level or at lower levels for individual resume (profile) items.

As more users 112 utilize system 100, associations among provided profiles 114 can be established. For example, two individuals 112 working for a common company, in the same location, during the same time period can be presumed to know each other, and can even be used to verify each others performance regardless of whether they list each other as references or not. The same can apply for people 112 attending the same university program during a common time period. When multiple individuals who should theoretically know a profile provider 112 due to commonalities do not, a verification rating associated with that entry can be lowered. Providers (job seekers) 112 and hiring companies (142) who use system 100 can be permitted/requested to verify information provided by others. A verification of a highly trusted source can have more weight than one provided from an unknown source. In one embodiment, comments and/or ratings can be submitted by information providers concerning information in a profile 114 of another. For example, an employer or an employee's peer can rate a performance of a profile provider 112, which can be optionally made available to the consumer 142.

A number of authority sources 162 can be additionally used to verify profile 114 information and/or to increase a trust rating of an entity. For example, an authority source 162 for verifying educational references can include server 160 that maintains university records for its students. Such a server 160 can verify resume items down to low levels, such as verifying grade point averages, courses taken, and the like. In this case, additional information from an authority server 160 not provided by a user 112 can be added to that user's profile 126, which can be made available to the profile consumers 142. In another example, an IRS server 160 can provide information to verify employment information contained in a profile 114. In still another example, a server 160 containing historical address information, such as old address and phone number records from telephone directories, can be used to verify that a provider 112 lived in an area during expected times, as listed for employment history and education history.

As shown in system 100, a set of profile providers 112 can provide profile 114 information concerning themselves, which is conveyed over network 150 and stored in server 120. The server 120 can include a profile manager 124 that manages a set of user profiles 126. Providers 112 can establish a set of user preferences 128, which specify who is to be given access to the profile 114 information and that indicate any provider 112 established restrictions regarding use of authority sources 162. Some preference 128 can require explicit provider 112 documents, such as documents permitting consumers 142 to access a particular authority source 162 for information related to the provider 112, such as authorizations to access IRS information, credit report information, university records, and the like. In one embodiment, a profile certification server 130 can access the authority source 162 once, and provide this information to multiple profile consumers 142 at need. For example, a single transcript request for educational information can be made by the certification server 130, which is thereafter stored and accessible at need to consumers 142.

Profile 114 can include a data set containing personal and/or professional information about provider 112. Information can include, but is not limited to, name, age, residential/business address, education, work history, credit rating, and the like. The profile 114 information can be stored as part of a user profile 126, which can contain supplemental information provided by other sources, such as transcript information, job performance ratings, referral comments, and the like. In one embodiment, supplemental information provided by others can be hidden from the provider 112. Each user profile 126 can be separated into one or more segments or items which can be independently verified. Verification of profile data can be performed by other providers 112, by one or more consumers 142, and/or by one or more authority sources 160.

Profile certification server 130 can be a computing device capable of verifying a profile 126 and tracking the verification process of the profile 126. Server 130 can include a validation engine 132 and a transaction engine 134. When the profile verification process is invoked, profile 126 information can be conveyed to profile certification server 130. In one embodiment, server 130 can be configured to provide verification capabilities as a Web service.

Validation engine 132 can be utilized to verify part or all of a profile 126. Profile information conveyed to validation engine 132 can be selectively processed based on authentication rules 136. The validation engine 132 can submit validation request to other providers 112, to profile consumers 142, and/or to one or more authority sources 162. Additionally, engine 132 can execute verification algorithms to identify intentional system 100 abuses (e.g. a closed circle of users who only authenticate each other). These verification algorithms can be of arbitrary complexity to ensure that profile information 126 has characteristics of real information as opposed to fabricated information. A learning loop can be used to ensure performance of the validation engine 132 improves over time with use.

Transaction manager 134 can be responsible for accounting and auditing the validation process and for handling financial concerns relating to a profile verification service. That is, each request/response transaction can have a monetary fee associated with the transaction. Fees can be based on the simplicity/complexity of the query performed by the certification server 130. Alternatively, fees can be determined based on session length or for each profile verification request performed. Information can be provided at different levels of granularity for different fees. Further, providers 112 and/or consumers 142 may have to pay a subscription fee for use of server 130 capabilities. Reports detailing authority sources 162 used to verifying profile data can be generated at request by manager 134 or by a reporting component of the server 130. Report data can include a transaction list, fees incurred, alternative authority sources 162 used, and the like.

Authentication rules 136 can be used to control the behavior of the verification process. Rules 136 can include usage of preferred authority servers 160, preferred sources 162, preferred profile attributes for verification, and the like. Rules 136 can be used to control whether specific profile information can be automatically or manually confirmed. Different sets of rules 136 can be established that are specific to consumers 142, which can be configured by the consumers 142.

A version of a profile available to the consumer 142 can be referred to as a verified profile 118. The verified profile 118 can comprise of confidence levels indicating a level of authenticity for a profile characteristic. As shown in verified profile 118, provider's 112 education can be “100% verified”, which can denote to the consumer 142 a high level of authenticity about provider's 112 education. Conversely, provider's 112 work history shown in profile 118 as “20% verified”, can convey a low level of confidence or indicate a partial validation of profile 114, 126 information.

Client 110 and 140 can include hardware/software computing device capable of computational tasks associated with profile creation, modification, verification, and presentation. Profile creation, manipulation, and presentation can occur through stand alone application, via Web browser graphical user interface (GUI), or via a Rich Internet Interface (RII). Client 110 can include, but is not limited to, desktop computer, laptop, mobile computing device, mobile phone, a kiosk, and the like.

The profile certification server 130 can be stand-alone server, a distributed server, or a cluster of servers. In one embodiment, the validation engine 132 and the transaction manager 134 can be implemented within separate computing systems and/or software packages. Additionally, the profile certification server 130 can be configured to directly integrate with consumer 142 specific human resource systems, which can include formatting profile 126 information in a consumer 142 specific manner, using authority sources 160 specified by a consumer 142, requesting additional profile 114 information from a provider 112 specific to a consumer 142, and the like.

Network 150 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 150 can include local components and data pathways necessary for communications to be exchanged among computing device components and between integrated device components and peripheral devices. The network 150 can also include network equipment, such as routers, data lines, hubs, and intermediary servers which together form a packet-based network, such as the Internet or an intranet. The network 150 can further include circuit-based communication components and mobile communication components, such as telephony switches, modems, cellular communication towers, and the like. The network 150 can include line based and/or wireless communication pathways.

The information managed by servers 120, 160, 130, and associated with consumer 142 can be stored in a one or more data stores. These data stores can be a physical or virtual storage spaces configured to store digital information. The data stores can be physically implemented within any type of hardware including, but not limited to, a magnetic disk, an optical disk, a semiconductor memory, a digitally encoded plastic memory, a holographic memory, or any other recording medium. Each of data stores can be a stand-alone storage unit as well as a storage unit formed from one or more physical devices. Additionally, information can be stored within the data stores in a variety of manners. For example, information can be stored within a database structure or can be stored within one or more files of a file storage system, where each file may or may not be indexed for information searching purposes. Further, the data stores can optionally utilize one or more encryption mechanisms to protect stored information from unauthorized access.

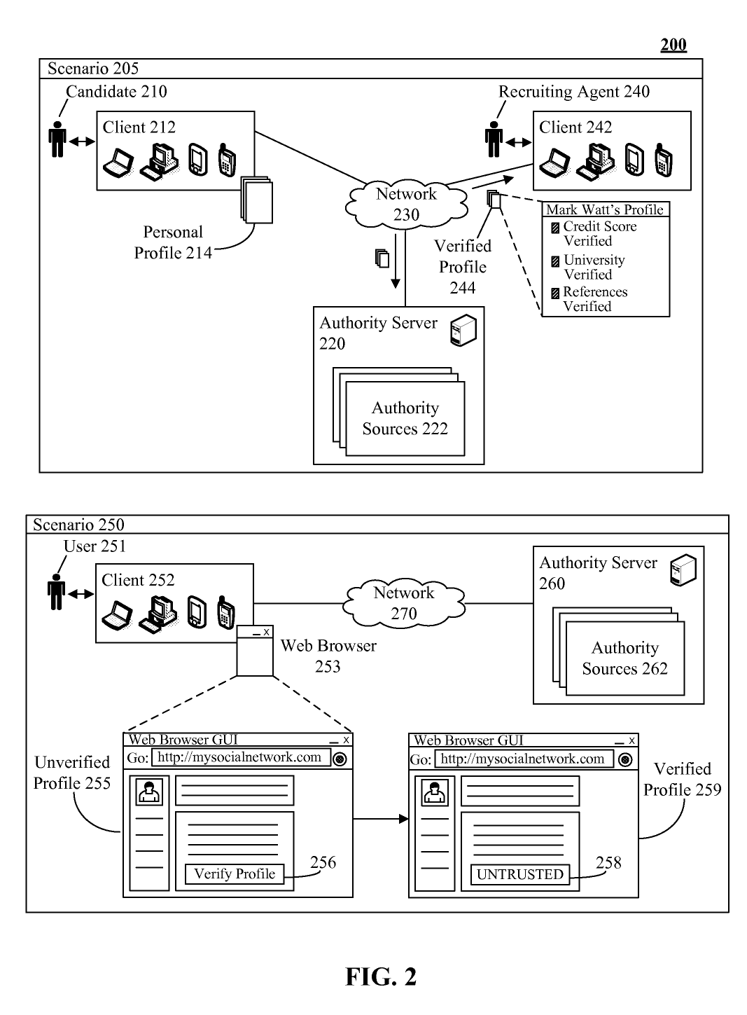

FIG. 2 is a schematic diagram illustrating a set of scenarios 205, 250 for using a verified profile to improve the quality of business and personal relations in accordance with an embodiment of the inventive arrangements disclosed herein. Scenarios 205 and 250 can be performed in the context of system 100. In scenarios 205 and 250 a verified profile can be created for use in establishing the authenticity of biographical information associated with an individual.

In scenario 205, a candidate 210 seeking employment can create a personal profile 214 containing useful information for job applications. Information, such as work history, education, and a list of references can be included in the profile 214. Using client 212, network 230, and authority server 220, candidate 210 can convey a verified version 244 of the personal profile 214 to one or more recruiting agents 240. Optionally, personal profile 214 can be conveyed to agent 240, who can submit it to authority server 220 for verification 244. Verification of candidate 210's biographical information can reduce the time and/or expense typically experience by a recruiting agent 240 when verifying the information manually (e.g. contacting references, past employers, etc).

Profile verification can be achieved using authority server 220 comprising of authority sources 222. Authority sources 222 can be educational records capable of establishing the validity of educational claims made by personal profile 214. In one instance, authority sources 222 can include social networking source(s), a credit bureau source, IRS records, police records, court records, university records, and the like.

Scenario 250 shows that verified job related information or just generic profile information can be used to enhance a trust level of a social network contact to minimize a likelihood that an individual being interacted with in a social networking setting is a sexual predator, a voyeur using a fictitious identity, and the like. For example, an unverified profile 255 can be initially entered by a user 251 via a browser 253 or other interface that is conveyed over network 270 to a social networking site. This information can be compared against information contained within one or more authority sources 262 through associated authority servers 260. When the information checks out, the profile can be verified 259 and the user 251 listed as trusted 258. In one embodiment, a user 251 can initialize the process to verify their profile 256 to gain a trusted status. In another embodiment, verification can be an automatic service provided by a social networking site to ensure a level of security to its users.

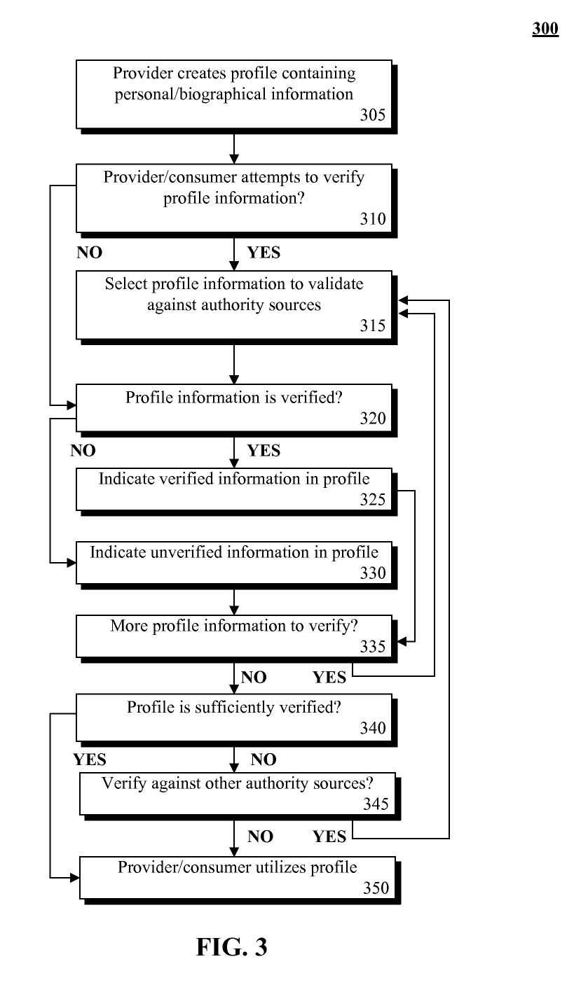

FIG. 3 is a flow chart illustrating a method 300 for verifying provider profile information for use by a profile provider and/or consumer in accordance with an embodiment of the inventive arrangements disclosed herein. Method 300 can be performed in the context of system 100. In method 300, provider profile information can be processed to establish the validity of profile information.

In step 305, a provider creates a profile containing person/biographical information. In step 310, if the provider and/or consumer attempts to verify profile information, the method can proceed to step 315, else proceed to step 320. In step 315, profile information is selected to be verified against one or more authority sources. Selected information can include one or more types of information including, social security number, national identification information, financial information, and the like. In step 320, if profile information is verified, the method can proceed to step 325, else the method can jump to step 330. In step 325, verified information can be indicated as authentic on the provider's profile. In step 330, unverified information can be indicated as unconfirmed data on the provider's profile.

In step 335, if there is more profile information to be verified, the method can return to step 315, else proceed to step 340. In step 340, if the profile is sufficiently verified for use by provider or consumer, the method can proceed to step 345, else jump to step 350. In step 345, profile information can be verified against other authority sources to increase confidence level of confirmed information or to verify unconfirmed data. Further verification can include methods manually performed by a human service agent, such as contacting difficult to reach sources, researching background data, and searching offline databases. The method can return to step 315 based on the determining step 345, else continue to step 350. In step 350, provider and/or consumer utilize profile for conducting personal and/or professional activities.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A network accessible software application comprising:
an interface permitting a set of profile providers to input personal biographical information, which includes job history information and education information;
an interface enabling a set of commentators to view biographical information provided by the set of profile providers and to add input regarding this information;
software configured to compute at least one verification score against the personal biographical information based at least in part upon the added input from the set of commentators; and
software configured to convey personal information along with the verification score to a set of profile consumers, wherein said interfaces are created by software, and wherein software used in this claim is stored upon a machine readable medium and is configured to be executed by at least one computing device causing the computing device to behave in the claimed manner.

2. The application of claim 1, wherein at least a portion of the commentators have a social networking connection to the profile providers for whom the added input is provided, weighing a validity of the added input based at least in part upon a strength of and a confidence level in the social networking connection.

3. The application of claim 1, wherein said commentators include peers, superiors, and subordinates believed to know said profile provider during a time period and for an activity specified within at least one of the job history information and the education information, wherein different ones of said comments have validated themselves with the software application and have an associated validation score; said method further comprising: weighing the added input provided by different commentators in accordance with the associated validation score.

4. The application of claim 1, wherein said personal information along with the verification scores are provided to the set of profile consumers for a fee.

5. The application of claim 1, wherein said software that computes the verification score includes a set of instructions causing a computing device executing those instructions to perform the steps of:
querying at least one authority source to validate items relating to the job history information and the education information contained in the personal biographical information, wherein when a plurality of profile consumers request verified personal information for a profile provider, the authority source needs to be queried only once for the plurality of profile consumers;
receiving results in response to the querying step; and
utilizing the results to calculate the at least one verification score.

6. The application of claim 1, wherein said software that conveys the personal information includes a set of instructions causing a computing device executing those instructions to perform the steps of:
establishing an interface between the application and a human resource system associated with at least one of the profile consumers; and
formatting the personal information and the verification score to conform to standards of the human resource system to which it is being conveyed.

7. The application of claim 1, wherein said interfaces used by said set of profile providers and by said set of commentators are Web interfaces.

8. The application of claim 1, wherein said verification score is used by at least one social networking application to indicate a level of trust that others interacting with the profile provider should have in the biographical information provided by the profile provider.

9. A method for utilizing social networking technology for job application purposes comprising:
a network element receiving a personal profile from a person comprising biographical information of that person, said biographical data including job history information and education information;
verifying said biographical information based at least in part upon social networking connections associated with the person; and
providing verified biographical information for the person to at least one hiring entity.

10. The method of claim 9, wherein said social networking connections comprise a plurality of connections to a first set of individuals having a first degree of separation to the person, wherein at least a portion of the individuals included in said first set have a plurality of connections to another set of individuals having a second degree of separation to the person, wherein information specific to individuals having a first degree of separation and a second degree of separation is considered when verifying the biographical information.

11. The method of claim 10, wherein social networking connections associated with the person are analyzed to determine if these connections conform to expected social networking structures typical for a person providing valid biographical information, wherein when the connections do not conform to expected social networking structures, the method assumes that the biographical information and references provided in the biographical information contains inaccurate data.

12. The method of claim 9, wherein the verifying step:
generates at least one verification score for the biographical data, which indicates whether the biographical data is likely to be accurate; and
presenting the at least one verification score to one of the remotely located hiring entities.

13. The method of claim 12, wherein the at least one verification score comprises a plurality of verification scores, each of which applies to an entry that is part of the biographical information.

14. The method of claim 9, further comprising:
comparing entries contained in the biographical data against entries included in personal profiles provided by other individuals;
determining a set of commonalities from the comparing step, which indicates a set of the other individuals who are to be considered as being in a geographic location as the person at a same time period that the person has indicated as being in the location;
contacting at least a portion of said set of other individuals to determine whether those individuals have knowledge of said person, wherein said verifying step considers results obtained from the other individuals during the contacting step.

15. The method of claim 9, wherein the network element performing the receiving, verifying, and providing steps is part of an automated computing system that is independent of the person and the hiring entities.

16. The method of claim 15, wherein the verified biographical information is provided as a for-fee-service to the hiring entities.

17. The method of claim 9, wherein said steps of claim 9 are performed by at least one machine in accordance with at least one computer program stored in a computer readable media, said computer programming having a plurality of code sections that are executable by the at least one machine.

18. A method for leveraging social networking information for an employment context comprising:
extracting from a social networking Web site information relating to biographical data provided as part of a resume by a profile provider;
algorithmically determining a set of verification scores for discrete entries contained in the biographical data using the extracted information;
utilizing additional input from at least one authority source to further refine the set of verification scores; and
providing the verification scores along with the biographical data to a plurality of hiring entities.

19. The method of claim 18, wherein said extracting, determining, utilizing, and providing steps are automatically performed by at least one computing system of an entity independent of the profile provider and independent of the hiring entities, said method further comprising:
integrating the computing system with human resource systems of the plurality of hiring entities so that the verification scores and the biographical data is provided directly to the human resource systems in a format compatible with the human resource systems.

20. The method of claim 18, further comprising:
receiving bibliographical data for a plurality of profile providers;
comparing entries contained in the biographical data against entries provided by other ones of the profile providers;
soliciting information through a Web site from these other profile providers;
receiving information from the other profile providers; and
using the received information as the additional input, wherein the other profile providers are considered to be authority sources.
